(19) United States
(12) Patent Application Publication
(10) Pub. No.: US 2010/0275416 A1
(43) Pub. Date: Nov. 4, 2010

(54) HANDLE WITH SOFT GEL CUSHIONING MEMBER

(76) Inventors: Richard B. Fox, Smithfield, RI (US); Daniel M. Wyner, North Sciluate, RI (US)

Correspondence Address: BOWDITCH & DEWEY, LLP, 311 MAIN STREET, P.O. BOX 15156, WORCESTER, MA, 01615-0156, US

(21) Appl. No.: 12/837,064

(22) Filed: Jul. 15, 2010

Related U.S. Application Data
(63) Continuation of application No. 11/615,178, filed on Dec. 22, 2006.
(60) Provisional application No. 60/753,871, filed on Dec. 23, 2005.

(51) Int. Cl. B25G 1/10

(52) U.S. Cl. 16/430

(57) ABSTRACT

The handle construction of the present invention includes a low durometer grip portion that provides comfort and an ergonomic benefit to the user. The handle includes a rigid core with a gel member received in a recessed seat. The gel member preferably has a durometer of 65 Shore 00 or less. A thin top finish layer, of elastomeric or polymer film, is optionally provided on the top of the gel member, such as in a thickness of less than 4 thousandths of an inch in thickness (<4 mil) to provide a durable and aesthetic surface. The combination of the molded low durometer gel member, with an otherwise rigid handle, allows for the creation of an overall handle that has areas that are more rigid along with areas that exhibit a very soft feel.

### CROSS-REFERENCE TO RELATED APPLICATIONS

This application is related to and claims priority from earlier filed provisional patent application Ser. No. 60/753,871, filed Dec. 23, 2005.

### BACKGROUND OF THE INVENTION

This invention relates generally to an innovative handle construction, that can be used on an implement or tool, such as for a toothbrush or razor. There are many different types of tools, implements and objects, such as razors and toothbrushes, that require fairly precise handling and yet both also benefit from having a soft feel for the user while handling.

In the prior art, by way of example, there are various razors or toothbrushes that are made of rigid plastic or metal and are thus hard to the touch. There have also been many attempts to make razors and toothbrushes that are more comfortable for human contact, such as by the hands and fingers. The entire razor or toothbrush does not need to be soft; rather it is desirable for much of these handles to be rigid so they are easy to control. It is generally thought to be desirable for the areas in contact with the fingers to be soft so as to lesson the pressure on the fingers. For this reason, prior art razors, toothbrushes and other tools and implements have been made with areas of softer materials. Because very low durometer gels are generally very sticky to the touch and have other undesirable surface characteristics, most of what are considered low durometer materials that are used in prior art razor and toothbrush handles are of a 50 shore A hardness or above.

In the prior art, in order to get the finished molded razor handle softer, for example, these 50 shore A or similar durometer plastics are often molded into shapes with thin “fins”. These thin fins can behave like a softer material, because the plastic will bend more easily at thin gauge. In this way, the prior art has attempted to create toothbrush and razor handles that have areas that are as soft as possible and yet durable.

There have also been examples in the prior art of the use of thermoplastic elastomers with durometers as low as 70 shore 00 hardness in toothbrush handles. TPE's in this hardness range have been used as some can be made to have acceptable surface characteristics and durability, and have not necessitated a film surface or polymer top finish coat.

In view of the foregoing problems associated with the prior art, there is a need for handles with significantly softer materials than are found in any of the prior art, such that the touch points will conform more readily to the pressure of the fingertips. There is a need for a handle construction, for use on razor, toothbrushes, and that like, that is more comfortable than those existing in the prior art. There is a need for a handle that incorporates three dimensional molded gel of less than 65 shore 00, and a top surface layer of elastomeric film or an elastomeric polymer surface coating.

### SUMMARY OF THE INVENTION

The present invention preserves the advantages of prior handles with cushioning elements therein. In addition, it provides new advantages not found in currently available cushioned handle constructions and overcomes many disadvantages of such currently available handle constructions.

The handle construction of the present invention includes a low durometer grip portion that provides comfort and an ergonomic benefit to the user. More specifically, the present invention relates to handles or any gripping surfaces or areas, such as for a toothbrush or razor, with a grip with both rigid areas and areas containing three-dimensional molded gel with a durometer of less than 65 shore 00. The grip areas with three dimensional molded low durometer gel also then have a thin top layer of elastomeric film of less than 4 thousandths of an inch in thickness (<4 mil) to provide a durable and aesthetic surface, or instead of the film they have an elastomeric polymer top-coating. The combination of the molded low durometer gel “medallions”, with an otherwise rigid grip, allows for the creation of a grip that has areas that are more rigid along with areas that exhibit a very soft feel. The thickness of the gel does not need to be uniform, but can be thicker in areas where such is advantageous or aesthetically pleasing to the user.

It is therefore an object of the present invention to provide a superior handle construction that is soft to the touch to the user in the appropriate locations.

There is a further object of the present invention to provide a handle construction that incorporates three dimensional gel material for superior comfort and control for the user.

There is also an object of the present invention to provide a handle construction that complements a rigid core to combine comfort and control in the same handle.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is perspective view of the a implement having a handle with a gel medallion in accordance with the present invention;

FIG. 2 is a cross-sectional view through the line 2-2 of FIG. 1 showing the preferred embodiment of the present invention;

FIG. 3 is a cross-sectional view through the line 2-2 of FIG. 1 showing an alternative embodiment of the present invention; and

FIG. 4 is a cross-sectional view through the line 2-2 of FIG. 1 showing a further alternative embodiment of the present invention.

### DETAILED DESCRIPTION OF THE PREFERRED EMBODIMENT

The present invention relates to the creation of a handle 10 for tools, implements and objects, such as handles for toothbrushes and razors, that is softer to the touch than any previous design, and yet is durable and aesthetically pleasing and is rigid enough for exacting control by the user. It should be understood that the construction of the present invention is shown and described in connection with a toothbrush and razor handle 10 by way of example for ease of discussion and illustration. Any type of tool, implement or object can take advantage of the construction of the present invention.

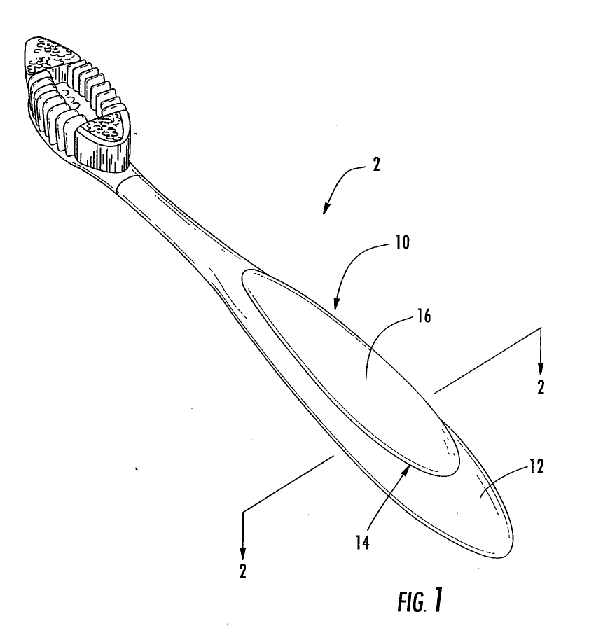

Turning first to FIG. 1, the invention includes an implement 2, such as a razor or toothbrush with a handle construction 10 containing a number of elements. First, a rigid shaped core 12 of plastic or metal provides structure and shape of the implement 2. One or more areas or “medallions” or members, generally referred to as 14, with a molded urethane, silicone or other polymer gel 16 of preferably less than 65 shore 00 durometer is also provided. One cushioning member 14 is shown, by way of example.

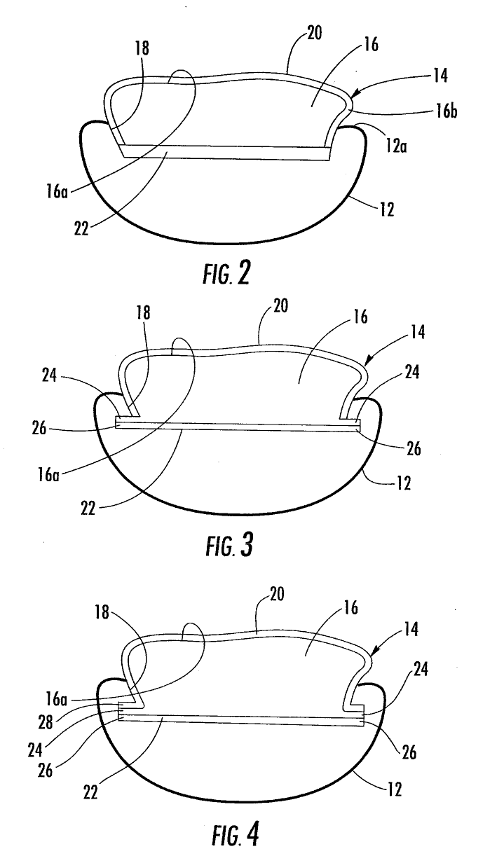

As can be seen in FIG. 2, preferably, the cushioning member 14 is located within a recess 18 formed in the rigid core 12 of the handle implement 2. A thin outer layer 20, such as an elastomeric polymer coating or elastomeric film covers the top surface 16a of the molded cushioning gel 16.

Optionally, this outer layer 20 can contain antimicrobial agents such as silver, copper and zinc. More specifically, nano-particle metals, including silver, copper and zinc, can be used as the antimicrobial agents, such as those manufactured by the Nano-Horizons Company. The outer layer 20, such as the film or polymer coating, can optionally contain antimicrobial agents to control the growth of bacteria. By having these antimicrobial agents in the top surface layer 20 only, they can be used very economically in small quantities and yet still be highly functional since they are on the entire surface. In one embodiment, an Omniflex 18411 film containing silver active agents can be employed as an antimicrobial. It is also possible to use a water-based polyurethane coating as layer 20 with silver antimicrobial additive. Other non-silver based antimicrobial agents can also be used in the top film or coating layer 20.

In addition, the outer layer 20 may contain phase change materials that can make the surface feel cool to the touch. Such phase change materials can be added to the outer layer 20, namely, a surface film or elastomeric surface coating. The addition of phase change materials such as phase change containing microspheres sold under the brand name of “Outlast” can create the sensation of coolness for the user as they absorb body heat. The Outlast material consists of small spheres filled with wax type materials that melt between 75 and 95 degrees F., which is just below body temperature. As these materials melt, they absorb heat. Because of the thin outer layer 20 in the present invention, these phase change materials can be added in small quantities and yet be present on the surface of the implement 2 to come in direct contact with the user of the implement 2. The construction of the present invention is thus well suited to deliver the benefits of these phase change materials in an economical way.

Optionally, the cushioning member 14, made of gel 16, can sit on a lower base layer 22, that may be any material, such as fabric, film, or nonwoven providing for stability. For example, FIGS. 2-4 illustrate various embodiments of the present invention employing this multilayer construction. This lower layer 22 of fabric, film, or nonwoven material can additionally be printed or colored to provide additional aesthetics.

In FIG. 2, it is preferred that the cushioning member 14, made of gel material 16, resides within a recess seat 18 of the rigid core member 12. The lower layer 22 resides therebetween. However, it is also possible that the rigid core 12 can be molded or shaped to partially or fully contain the molded cushioning member 14, of the gel material 16, can extend entirely outside of the rigid core 12. In FIG. 3, the gel member 16 includes a flange 24 while the lower layer also includes a flange 26. These flanges 24, 26 extend outwardly for encapsulation by the rigid core member 12. In this example, it is preferred that the rigid core member 12 molded to encapsulate the flanges 24, 26 of the gel material 16 and lower layer 22. As a result, the gel member 16 and lower layer 22 are fixedly secured to the rigid core 12. FIG. 4 further shows that all layers, namely, the gel material 16, top surface finish layer 20 and lower layer 22 all emanate outwardly to provide respective flanges 24, 26 and 28 for encapsulation during the molding or formation process. It is also possible that this flange can be locked in by snapping together two “clamshell” pieces rather than during the molding or formation of the rigid core. If a line were to be drawn on the diagram showing that the rigid core is two snapped-together pieces locking in the flange, this might show a more likely typical use. Also, another embodiment is possible where just the lower layer 26 is the flange, and neither the gel nor the top layer are locked in.

The rigid core 12 and the gel member 16 act together to provide both stability and comfort to the user. It should be understood that each layer can be molded and formed using different methods and of appropriate varying thicknesses and shapes to achieve the best comfort and aesthetics for a given application.

It has been found that a molded gel member 16 with a durometer of less than 65 shore 00 is preferred. More generally, a preferred range for the hardness of the gel member 16 for aesthetics and durability of the handle is between 25 shore 00 and 60 shore 00. However, a gel material 16 having a hardness greater or less than this range can also be used. One preferred embodiment of the invention uses a polyurethane gel with a durometer of 50-55 shore 00.

The gel member 16 may optionally be finished with a top layer 20. This top layer 20 may be in many different forms. For example, the top layer 20, as seen in FIGS. 2-4, may be a film, such as an elastomeric film with a preferred thickness of less than 4 mil. Generally, for the top finish layer 20, it is desirable to have a film less than 2 mil thick to provide for the best combination of softness and durability. In some cases, films of up to 4 mil in thickness may be necessary to pass certain puncture or bite specifications. It has been found that for many uses a polyurethane film with a thickness of between 0.4 mil and 1.0 mil works very well. Greater thickness provides for less softness but more durability. The top finish layer 20 is preferably an elastomeric film so that it can move with the gel. Non-elastomeric films, although they can be used, are not as desirable because they will feel hard even over a very soft gel member. In one embodiment of the invention, a style 18411 0.75 mil film manufactured by Omniflex LLC of Greenfield, Mass. has been used with good results.

As an alternative to the outer surface layer 20 being a film covering, the gel material 16 can be coated with a thin layer of elastomeric polymer coating. In accordance with the present invention, a water-based polyurethane top coating 20 is employed, but other elastomeric coatings can be used including other types of water based coatings, 100% solids coatings and solvent based coatings.

The outer finish layer 20 provides for encapsulation of the molded low durometer gel material 16, so that there is an aesthetically pleasing point of contact for the user. Either the elastomeric surface film or the polymer top-coating can be pigmented, printed up or transparent depending on the desired aesthetics.

Because the gel material 16 in the present invention is extremely soft, it is sometimes undesirable to have the edge 16b of the molded gel 16 flush with the more rigid plastic. This can create a sharp or hard feeling at the transition point between the gel member 16 and the recess seat 18 of the more rigid core member 12. This is generally not a problem in the prior art, because the prior art uses higher durometer materials that are not so dramatically softer than the surrounding materials. In the present invention, because of the use of very low durometer gel materials 16, it is often desirable to have the edges 16b of molded gel material 16 raised above the top edge 12a of the rigid core member 12 as seen in the cross-sectional views in FIGS. 2-4. In this way, the user is not exposed to a hard edge at the transition point.

It has also been found that it is often desirable to have a lower layer of material 22, such as a film, fabric or nonwoven material bonded to the underside of the gel member 16 for the purpose of adding stability and durability to the gel member 16. In accordance with the present invention, a polyester film in a thickness of 2 mil may be employed for this purpose. It has also been found that many fabrics (both knitted and woven) can work well in adding stability to the product. Also, a nonwoven material can be used in this lower layer 22.

In addition to stabilizing the product, it has also been found that a clear or tinted molded gel material 16 transmits the aesthetics of the lower layer 22, in the form of a fabric, film, or nonwoven material positioned therebelow. Thus it is often desirable to have a colored or printed film or fabric beneath the gel member 16 for aesthetic purposes. It has been found that printed polyester films, or dyed or printed fabrics or nonwovens can all work well in this regard for the lower layer 22. In accordance with the present invention, a printed knitted polyester fabric beneath the gel material 16 can be used, for example. Also, for example, a printed polyester film beneath the gel member 16 may be used. In each case, the surface aesthetics of the gel member 16 takes on the color or printing of the lower layer 22 disposed therebelow. The addition of this printed or colored lower layer can greatly contribute to the aesthetics of the finished implement 2, namely, a toothbrush or razor, and the like.

The present invention allows for a novel integration of materials for any type of tool, implement or object, such as the handle 10 for a toothbrush or razor, providing for a softer feel not found in the prior art. The ability to further enhance the aesthetics by providing graphics that show through the gel material 16 is an advance over the prior art. Further, the addition of surface antimicrobial materials or phase change materials to a cushioning gel member 16 in a handle 10 creates additional advantages unseen in any prior art.

It would be appreciated by those skilled in the art that various changes and modifications can be made to the illustrated embodiments without departing from the spirit of the present invention. All such modifications and changes are intended to be within the scope of the present invention.

1. An improved handle, comprising:
a rigid core defining a recess seat therein having a top edge;
a molded gel member disposed in the recess seat, the molded gel member comprising a first material comprising a durometer of 65 Shore 00 or less; and
an outer layer disposed adjacent to the molded gel member, opposite the rigid core, the outer layer comprising a second material different from the first material.

2. The improved handle of claim 1, further comprising an antimicrobial agent in the outer layer.

3. The improved handle of claim 1, thither comprising a phase-changing material in the outer layer.

4. The improved handle of claim 1, further comprising an antimicrobial agent and a phase-changing material in the outer layer.
